(19) United States
(12) Patent Application Publication
(10) Pub. No.: US 2009/0278415 A1
(43) Pub. Date: Nov. 12, 2009

(54) CORELESS MOTOR HAVING ROTORS ARRANGED CONCENTRICALLY AND DRIVING APPARATUS HAVING THE MOTOR

(76) Inventor: Kye-Jung Park, Daegu (KR)

Correspondence Address: LOWE HAUPTMAN HAM & BERNER, LLP, 1700 DIAGONAL ROAD, SUITE 300, ALEXANDRIA, VA, 22314, US

(21) Appl. No.: 12/302,475

(22) PCT Filed: May 17, 2007
(86) PCT No.: PCT/KR07/02417

§ 371 Date: Nov. 25, 2008

(30) Foreign Application Priority Data
May 29, 2006 (KR) 10-2006-0048274

(51) Int. Cl. H02K 21/12; H02K 7/10

(52) U.S. Cl. 310/156.08; 310/77; 903/906; 310/114

(57) ABSTRACT

The present invention relates to a coreless motor including a multi-stage rotor and a driving apparatus having the motor. More particularly, the present invention relates to a coreless motor including magnets and coils arranged, in multiple stages, to be concentric with a rotary central shaft and a driving apparatus having the a motor. According to an aspect of the present invention, a coreless motor including a multi-stage rotor comprises a rotor and a stator. The rotor includes a plurality of cylindrical yokes arranged in multiple stages in a radial direction, and a plurality of magnets fixed to the yokes in the respective stages in such a manner that polarities of the magnets fixed to the yoke in each stage are changed in a circumferential direction of the yoke. Further, the stator includes a plurality of cylindrical armature coil assemblies arranged in multiple stages to face the yokes, and each armature coil assembly includes a plurality of armature coils. The armature coils can be rigidly fixed using an epoxy resin to maintain their rigidity. Thus, the motor can produce power in a highly efficient way since it includes the multi-stage rotor and stator. Further, since the motor does not include a core, no cogging torque is produced to prevent the reduction of output torque and the output torque is kept constant to suppress noise and vibration.

### TECHNICAL FIELD

The present invention relates to a coreless motor including a multi-stage rotor and a driving apparatus having the motor. More particularly, the present invention relates to a coreless motor including magnets and coils arranged in multiple stages to be concentric with a rotary central shaft and a driving apparatus having the motor.

### BACKGROUND ART

FIG. 12 is a schematic view showing the concept of a conventional motor. The conventional motor includes a central shaft 1, a stator 5 and a rotor 3. The rotor 3 is composed of a yoke 4 and a permanent magnet 2 fixed to the yoke 4, and is rotatably coupled to the central shaft 1 via a bearing 6. The permanent magnet 2 is coupled to the yoke 4 in such a manner that their polarities are opposite to each other.

The stator 5 is formed by winding a coil around an armature core, and is fixed to the central shaft 1. Thus, if a current is supplied to the coil, a magnetic field is formed around the coil. A magnetic flux generated around the coil and a magnetic flux caused by the permanent magnet 2 are overlapped with and cancelled by each other, so that a magnetomotive force is generated due to a density difference in the magnetic fluxes. The magnetomotive force causes the rotor 3 to rotate on the central shaft 1.

Due to the influence on environment caused by air pollution and the depletion of fossil fuel, great attention is drawn on a driving apparatus using an electric motor. Thus, a hybrid vehicle or the like, in which an engine is used as a main driving source and an electric motor is used as an auxiliary driving source, has been developed and put into the market. Furthermore, an electric vehicle in which an electric motor is used as a main driving source is also being developed. Accordingly, an electric motor capable of generating greater output has been required.

However, the conventional motor is composed of a permanent magnet and a coil each of which is formed in a single stage. Thus, since the conventional motor has a very small magnetomotive force, there is a problem in that small torque is generated. Further, the motor should be bulky to generate sufficient output. In this case, however, the electric motor can be hardly utilized as a driving source of a vehicle.

Furthermore, a coil has been wound around an armature core in the conventional motor. Therefore, there is another problem in that the conventional motor is heavy due to the presence of the armature core.

Moreover, since the motor cannot generate uniform output torque due to the presence of the armature core, a cogging phenomenon occurs in which the rotor rattles while it rotates on the stator. Therefore, the cogging phenomenon causes the loss of output from the conventional motor, and thus, vibration and noise are generated while the motor is rotating.

### DISCLOSURE

### Technical Problem

The present invention is conceived to solve the aforementioned problems. That is, an object of the invention is to provide a motor having rotors and stators which are arranged in multiple stages to provide strong output even though the motor is small. Further, another object of the present invention is to provide a driving apparatus using the above motor by adopting the motor as a driving source of a car, a motorcycle or other vehicles.

In addition, a further object of the present invention is to provide a coreless motor which is light and does not cause a cogging torque, and a driving apparatus using the motor.

### Technical Solution

According to an aspect of the present invention, a coreless motor including a multi-stage rotor comprises a rotor and a stator. The rotor includes a plurality of cylindrical yokes arranged in multiple stages in a radial direction, and a plurality of magnets fixed to the yokes in the respective stages in such a manner that polarities of the magnets fixed to the yoke in each stage are changed in a circumferential direction of the yoke. Further, the stator includes a plurality of cylindrical armature coil assemblies arranged in multiple stages to face the yokes, and each armature coil assembly includes a plurality of armature coils. The armature coils can be rigidly fixed using an epoxy resin to maintain their rigidity. Thus, the motor can produce power in a highly efficient way since it includes the multi-stage rotor and stator. Further, since the motor does not include a core, no cogging torque is produced to prevent the reduction of output torque and the output torque is kept constant to suppress noise and vibration.

The motor is preferably configured such that the magnets are fixed to circumferential surfaces of the yokes facing in the radial direction. That is, since the magnets are fixed to the circumferential surfaces of the facing yokes and the armature coils are arranged to correspond to the magnets, a small-sized motor including multi-stage rotor and stator can be realized.

The motor may further include a fixed shaft positioned at a rotation center of the rotor. In this case, the rotor may further include a yoke coupling means for rotatably coupling each of the yokes to the fixed shaft, and the stator may further include a coil coupling means for fixedly coupling each of the armature coil assemblies to the fixed shaft. Thus, if the rotor is connected to a wheel of a tire or the like, the motor can be used as a driving apparatus of vehicles (e.g., a car, a motor scooter and an electric bicycle), wind generator or other industrial machines. In this case, since the shaft is fixed and the housing is rotated, it is preferred that the motor be connected to the wheel of the tire of a two-wheeled vehicle such as a motorcycle.

Each of the armature coil assemblies may be detachably coupled to the coil coupling means. Preferably, a yoke positioned inside an inner circumference of the armature coil assembly is detachably coupled to the yoke coupling means. More preferably, the coil coupling means is a fixed disk whose one surface is detachably coupled to one side of each armature coil assembly, and the fixed disk is fixedly coupled to the fixed shaft. More preferably, the yoke coupling means is a rotating disk whose one surface is coupled to one side of each yoke, and the rotating disk is rotatably coupled to the fixed shaft. Since the armature coil assemblies and the yokes are detachably coupled to one surface of the fixed disk and the rotating disk, respectively, the motor can be easily assembled or dissembled.

Furthermore, the motor may further comprise a rotating shaft instead of the fixed shaft. In such a case, the rotor may further include a yoke coupling means for fixedly coupling each of the yokes to the rotating shaft, and the stator may further include a coil coupling means for rotatably coupling each of the armature coil assemblies to the rotating shaft. Here, the motor rotates the rotating shaft. Thus, in a case where the rotating shaft of the motor is used as an axle of a vehicle, the motor can be used as a driving apparatus of the vehicle.

Each of the armature coil assemblies may be detachably coupled to the coil coupling means. Preferably, the coil coupling means is a fixed disk whose one surface is detachably coupled with one side of each armature coil assembly, and the fixed disk is rotatably coupled to the rotating shaft. More preferably, the yoke coupling means is a rotating disk whose one surface is coupled to one side of each yoke, and the rotating disk is fixedly coupled to the rotating shaft. Further, the rotor may further include a yoke fixed to the rotating shaft. A yoke positioned between the armature coil assemblies adjacent to each other may be detachably coupled to the one surface of the rotating disk.

The motor of the present invention comprises the multi-stage rotor and stator in a radial direction. The motor may further comprise the multi-stage rotor and stator in an axial direction.

To this end, the rotor may further include yokes and magnets additionally arranged in at least one more stage in an axial direction, and the stator may further include a plurality of armature coil assemblies additionally arranged to face the additional yokes.

Preferably, the magnets are fixed to circumferential surfaces of the yokes facing in the radial direction. Thus, since the rotor and the stator can be arranged in the axial direction as well as in the radial direction, a high output motor can be realized.

The motor may further comprise a fixed shaft positioned at a rotation center of the rotor. In such a case, the rotor may further include a yoke coupling means for rotatably coupling each of the yokes to the fixed shaft, and the stator may further include a coil coupling means for fixedly coupling each of the armature coil assemblies; to the fixed shaft.

Each of the armature coil assemblies may be detachably coupled to the coil coupling means. Each of the yokes may be detachably coupled to the yoke coupling means. Preferably, the coil coupling means is a plurality of rotating disks arranged in multiple stages in an axial direction, and one surface of each rotating disk is detachably coupled to one side of each of the armature coil assemblies arranged in multiple stages in the radial direction. More preferably, the yoke coupling means is a plurality of fixed disks arranged in multiple stages in an axial direction, and one surface of each fixed disk is coupled to one side of each of the yokes arranged in multiple stages in the radial direction.

The motor may further comprise a rotating shaft positioned at a rotation center of the rotor. In such a case, the rotor may further include a yoke coupling means for fixedly coupling each of the yokes to the rotating shaft, and the stator may further include a coil coupling means for rotatably coupling each of the armature coil assemblies to the rotating shaft. Preferably, each of the armature coil assemblies is detachably coupled to the coil coupling means. Preferably, the yoke coupling means detachably couple each of the yokes to the rotating shaft. Preferably, the coil coupling means is a plurality of rotating disks arranged in multiple stages in an axial direction, and one surface of each rotating disk is detachably coupled to one side of each of the armature coil assemblies arranged in multiple stages in the radial direction.

According to another aspect of the present invention, there is provided a driving apparatus, which comprises any one of the aforementioned motors, a brake disk fixed to the rotor of the motor, and a caliper installed to one side of the brake disk to restrict rotation of the brake disk.

Further, the caliper is preferably fixed to one side of the fixed shaft.

### DESCRIPTION OF DRAWINGS

FIG. 1 is a sectional view showing a motor having a multi-stage rotor according to an embodiment of the present invention.

FIG. 2 is a side sectional view of the motor shown in FIG. 1.

FIG. 3 is a perspective view showing the arrangement of armature coil assemblies and magnets of the motor shown in FIG. 1.

FIG. 4 is a sectional view showing a motor having a multi-stage rotor according to another embodiment of the present invention.

FIG. 5 is a side sectional view of the motor shown in FIG. 4.

FIG. 6 is a sectional view showing a motor having a multi-stage rotor according to a further embodiment of the present invention.

FIG. 7 is a sectional view showing a motor having a multi-stage rotor according to a still further embodiment of the present invention.

FIG. 8 is a sectional view showing a motor having a multi-stage rotor according to a still further embodiment of the present invention.

FIG. 9 is a sectional view showing a motor having a multi-stage rotor according to a still further embodiment of the present invention.

FIG. 10 is a front sectional view showing a driving apparatus using the motor shown in FIG. 4.

FIG. 11 is a side sectional view of the driving apparatus shown in FIG. 10.

FIG. 12 is a schematic view showing the concept of a conventional motor.

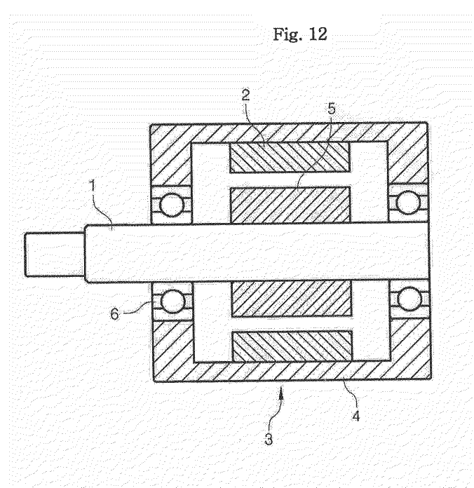

### BRIEF DESCRIPTIONS OF REFERENCE NUMERALS IN THE DRAWINGS

| | |
|---|---|
| 10: Rotating shaft | 20: Rotor |
| 21: First yoke | 23: Second yoke |
| 25: Third yoke | 27: Fourth yoke |
| 29: First magnet | 31: Second magnet |
| 33: Third magnet | 35: Fourth magnet |
| 37: Fifth magnet | 39: Sixth magnet |
| 41: Rotating disk | 43: Bolt |
| 50: Stator | 51: Third armature coil assembly |
| 53: Second armature coil assembly | 55: First armature coil assembly |
| 57: Fixed disk | 59: Coil fitting |
| 61: Bolt | 63: Bearing |
| 170: Motor | 171: Wheel |
| 173: Tire | 175: Caliper |
| 177: Brake disk | |

### BEST MODE

Hereinafter, a coreless motor having a multi-stage rotor and a driving apparatus according to preferred embodiments of the present invention will be described in detail with reference to the accompanying drawings.

A coreless motor having a multi-stage rotor according to the present invention will be first explained.

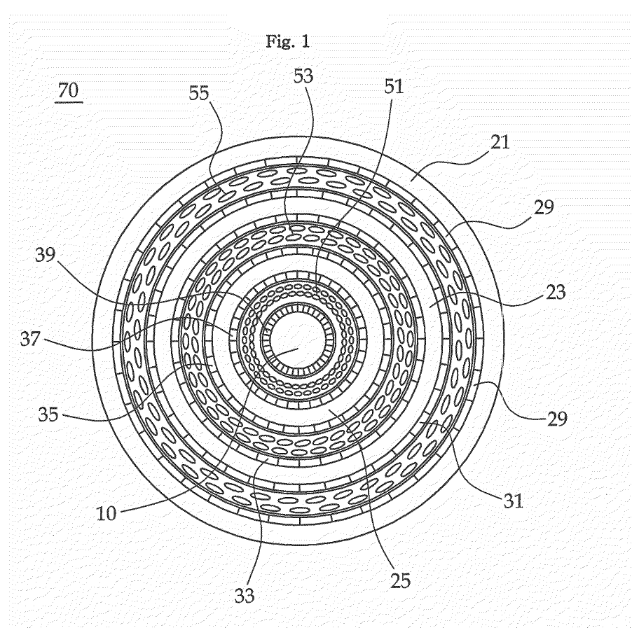

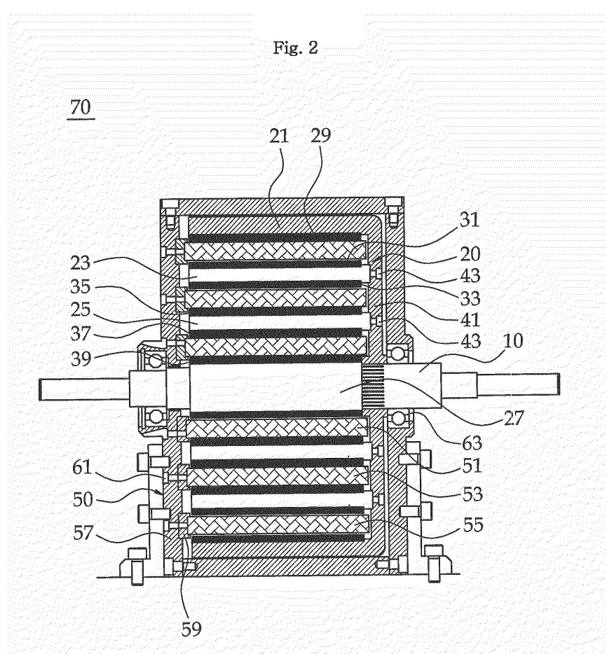

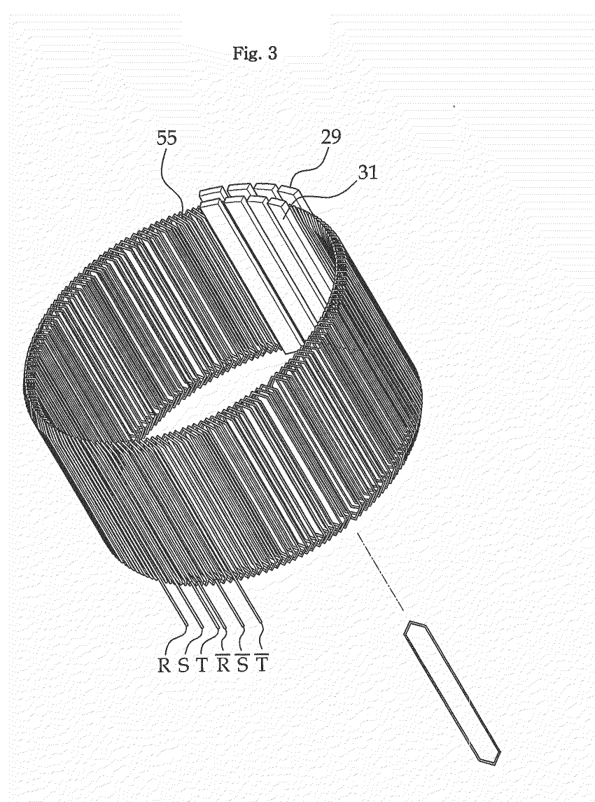

FIG. 1 is a sectional view showing a motor having a multi-stage rotor according to an embodiment of the present invention, FIG. 2 is a side sectional view of the motor shown in FIG. 1, and FIG. 3 is a perspective view showing the arrangement of armature coil assemblies and magnets of the motor shown in FIG. 1.

The motor 70 of FIG. 1 includes a rotating shaft 10, a rotor 20 and a stator 50.

The rotor 20 includes yokes 21, 23, 25 and 27, magnets 29, 31, 33, 35, 37 and 39, and a rotating disk 41. The rotating disk 41 is fixed to the rotating shaft 10. The yokes 21, 23, 25 and 27 are cylindrical and are arranged in four stages in a radial direction. That is, the first yoke 21 having the greatest size is arranged at an outermost position, and the second, third and fourth yokes 23, 25 and 27 are arranged inwards in order of their sizes. Although the yokes of this embodiment are arranged in four stages in a radial direction, they may be arranged in different stages, if necessary. One lends of the second and third yokes 23 and 25 are coupled to one side of the rotating disk 41 through bolts 43. Thus, the second and third yokes 23 and 25 can be detachably coupled to the rotating disk, so that they can be easily assembled and dissembled. In addition, the first yoke 21 is integrally coupled with the rotating disk 41 to define a housing of a motor, and the fourth yoke 27 is fixed to the rotating shaft 10. The magnets 29, 31, 33, 35, 37 and 39 are composed of a first magnet 29, a second magnet 31, a third magnet 33, at fourth magnet 35, a fifth magnet 37 and a sixth magnet 39. Similarly to the yokes, the magnets may also be configured in different stages. The magnets are fixed to the facing circumferences of the yokes. That is, the first and second magnets 29 and 31 are fixed to the facing circumferences of the first and second yokes 21 and 23, respectively. More specifically, a plurality of the first magnets 29 are fixed to the inner circumference of the first yoke 21 along a circumferential direction, and a plurality of the second magnets 31 are fixed to the outer circumference of the second yoke 23. Thus, the first and second magnets 29 and 31 are arranged to face each other. Similarly, the third magnet 33 is fixed to the inner circumference of the second yoke 23, and the fourth magnet 35 is fixed to the outer circumference of the third yoke 25 to face the third magnet 33. Further, the fifth magnet 37 is fixed to the inner circumference of the third yoke 25, and the sixth magnet 39 is fixed to the fourth yoke 27 to face the fifth magnet 37. Furthermore, the magnets 29, 31, 33, 35, 37 or 39 are fixed in such a manner that their polarities are changed in the circumferential direction along the circumferences of the yoke 21, 23, 25 or 27. In addition, each of the magnets 29, 31, 33, 35, 37 or 39 are arranged in such a manner that the facing magnets have opposite polarities.

The stator 50 includes a fixed disk 57 and armature coil assemblies 51, 53 and 55. The fixed disk 57 is coupled to the rotating shaft 10 through a bearing 63. Thus, the rotating shaft 10 can freely rotate with respect to the fixed disk 57. The armature coil assemblies 51, 53 and 55 are composed of a first armature coil assembly 55, a second armature coil assembly 53 and a third armature coil assembly 55. Each of the armature coil assemblies 51, 53 and 55 takes the shape of a cylinder and is formed by coupling three armature coils R, S and T wound in a radial direction along the length of the cylinder. In addition, each of the armature coil assemblies 51, 53 and 55 is configured in such a manner that the armature coils R, S and T are wound and then rigidly fixed to each other using a resin such as epoxy, to maintain its constant rigidity. The first armature coil assembly 55 is arranged between the first and second magnets 29 and 31 to face the first and second magnets 29 and 31 to each other, and one side thereof is fixed to one surface of the fixed disk 57. Referring to FIG. 3, the armature coils constituting the first armature coil assembly 55 are wound in such a manner that they extend along a length direction in parallel to the first magnet 29 and then bent in a radial direction and finally extend along the second magnet 31. The second armature coil assembly 53 is fixed to the surface of the fixed disk 57 such that they can be arranged between the third and fourth magnets 33 and 35, and the third armature coil assembly 51 is fixed to the surface of the fixed disk 57 such that they can be arranged between the fifth and sixth magnets 37 and 39. In addition, the armature coil assemblies 51, 53 and 55 are fixed to coil fittings 59 and then coupled to the fixed disk 57 through bolts 61, respectively. Similarly to the second and third yokes 23 and 25, therefore, the armature coil assemblies 51, 53 and 55 are detachably coupled to the fixed disk 57. The armature coils may be connected in parallel or series, and both Δ-connection and Y-connection are applicable thereto.

If a current is supplied to the armature coil assemblies 51, 53 and 55, a magnetic field is generated and the magnetic field generated by the armature coil assemblies 51, 53 and 55 interacts with a magnetic field generated by the magnets 29, 31, 33, 35, 37 and 39 to produce a rotating force. Thus, the rotor 20 and the rotating shaft 10 are integrally rotated. Accordingly, if the rotor 20 or rotating shaft 10 is connected to wheels of a vehicle or the like, the motor can be used as a driving source.

Meanwhile, the motor 70 may also be used as an electric generator. That is, if the rotor 20 performs a rotating motion, an induced current is generated in the armature coil assemblies 51, 53 and 55 through the magnets 29, 31, 33, 35, 37 and 39 fixed to the rotor 20.

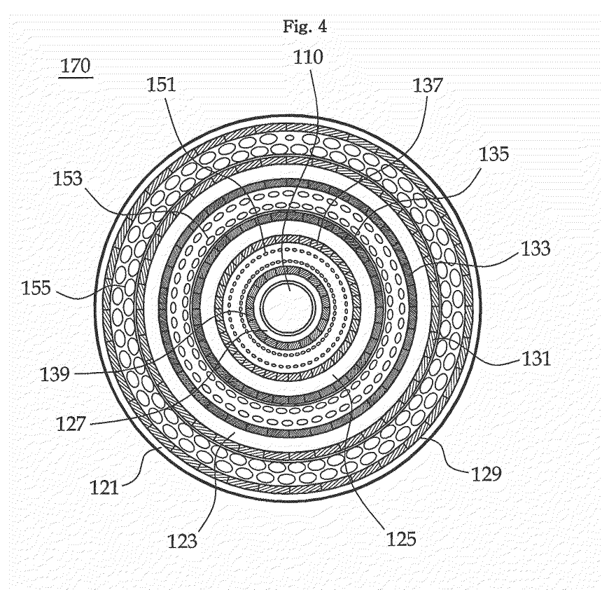

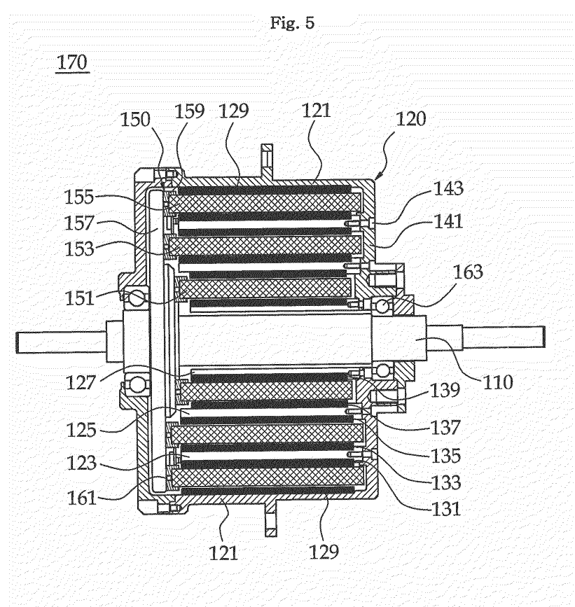

FIG. 4 is a sectional view showing a motor having a multi-stage rotor according to another embodiment of the present invention, and FIG. 5 is a side sectional view of the motor shown in FIG. 4. The motor shown in FIG. 1 includes a rotating shaft, whereas the motor shown in FIG. 4 includes a fixed shaft.

The motor of FIG. 4 includes a fixed shaft 110, a rotor 120 and a stator 130.

The rotor 120 includes a rotating disk 141, yokes 121, 123, 125 and 127, and magnets 129, 131, 133, 135, 137 and 139. The rotating disk 141 is coupled to the fixed shaft 110 through a bearing 163. The yokes 121, 123, 125 and 127 are cylindrical and are arranged in a radial direction, and they are composed of four stages including a first yoke 121, a second yoke 123, a third yoke 125 and a fourth yoke 127 which are arranged in order of diameter sizes. Of course, the yokes may be configured in different stages, if necessary. The first yoke 121 is fixed to the rotating disk 141, while the second, third and fourth yokes 123, 125 and 127 are detachably coupled to the rotating disk 141 through bolts 143. The magnets 129, 131, 133, 135, 137 and 139 are composed of a first magnet 129, a second magnet 131, a third magnet 133, a fourth magnet 135, a fifth magnet 137 and a sixth magnet 139. Similarly to the embodiment shown in FIG. 1, the magnets 129, 131, 133, 135, 137 and 139 are fixed to the yokes 121, 123, 125 and 127.

The stator 150 includes a fixed disk 157, and armature coil assemblies 151, 153 and 155. The fixed disk 157 is fixed to the fixed shaft 110. The armature coil assemblies 151, 153 and 155 have the same configurations as those of the embodiment shown in FIG. 1. That is, the armature coil assemblies 151, 153 and 155 are composed of a first armature coil assembly 155, a second armature coil assembly 153 and a third armature coil assembly 151. The first armature coil assembly 155 is arranged between the first and second magnets 129 and 131, the second armature coil assembly 153 is arranged between the third and fourth magnets 133 and 135, and the third armature coil assembly 151 is arranged between the fifth and sixth magnets 137 and 139. Similarly to the embodiment shown in FIG. 1, the armature coil assemblies 151, 153 and 155 are detachably coupled to the fixed disk 157 through coil fittings 159 and bolts 161, respectively.

If electric power is supplied to the armature coil assemblies 151, 153 and 155 of the motor 170, a torque is generated, and the rotor 120 rotate on the fixed shaft 110 due to the generated torque. Thus, if the rotor 120 is connected to wheels of a vehicle such that the motor 170 can be used as a driving apparatus of the vehicle. Moreover, in a case where the rotor 120 is driven using an external force, an induced current is generated in the armature coil assemblies 151, 153 and 155, so that the motor 170 can also be used as an electric generator.

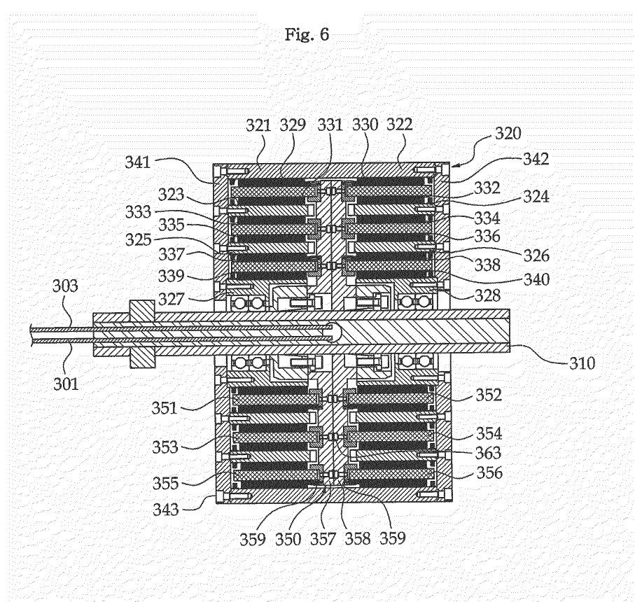

FIG. 6 is a sectional view showing a motor having a multi-stage rotor according to a further embodiment of the present invention. The motors of the embodiments shown in FIGS. 1 and 4 have the multi-stage rotor and stator in a radial direction, but the motor of the embodiment shown in FIG. 6 has multi-stage rotor and stator in an axial direction as well as in a radial direction.

The motor shown in FIG. 6 includes a fixed shaft 310, a rotor 320 and a stator 330.

The rotor 320 includes rotating disks 341 and 342, a first row of yokes 321, 323, 325 and 327, a second row of yokes 322, 324, 326 and 328, a first row of magnets 329, 331, 333, 335, 337 and 339, and a second row of magnets 330, 332, 334, 336, 338 and 340. The rotating disks are composed of a first rotating disk 341 and a second rotating disk 342, and they are arranged in an axial direction and rotatably coupled to the fixed shaft 310. The first row of yokes 321, 323, 325 and 327 are arranged in multiple stages in a radial direction and detachably coupled to the first rotating disk 341 through bolts 343. Further, the second row of yokes 322, 324, 326 and 328 are arranged in multiple stages in a radial direction and detachably coupled to the second rotating disk 342 through 343. In addition, the first row of yokes 321, 323, 325 and 327 and the second row of yokes 322, 324, 326 and 328, each of which are arranged in a radial direction, are arranged in two stages in an axial direction. In this embodiment, the outermost yokes 321 and 322 in a radial direction are also detachably coupled with each other to define a housing of the motor. The first row of magnets 329, 331, 333, 335, 337 and 339 are fixed to the first row of yokes 321, 323, 325 and 327, while the second row of magnets 330, 332, 334, 336, 338 and 340 are fixed to the second row of yokes 322, 324, 326 and 328. Therefore, the rotor 320 has a multi-stage structure in a radial direction as well as in an axial direction.

The stator 350 includes fixed disks 357 and 358, a first row of armature coil assemblies 351, 353 and 355, and a second row of armature coil assemblies 352, 354 and 356. The fixed disks 357 and 358 are composed of a first fixed disk 357 and a second fixed disk 358, and they are arranged in an axial direction and fixed to the fixed shaft 310. The first row of armature coil assemblies 351, 353 or 355 is arranged between the first row of magnets 329 and 331; 333 and 335; or 337 and 339, whereas the second row of armature coil assemblies 352, 354 or 356 are arranged between the second row of magnets 330 and 332; 334 and 336; or 338 and 340. In addition, the first row of armature coil assemblies 351, 353 and 355 and the second row of armature coil assemblies 352, 354 and 356 are fixed to coil fittings 359 and then coupled to the fixed disks 357 and 358 through bolts 363, respectively.

Reference numerals 301 and 303, which have not yet explained, designate an R.S.T. cable of the armature coil assembly and a sensor for checking a time when power supply is triggered in a case where the motor is used as an electric motor. Thus, the motor shown in FIG. 6 includes a multi-stage rotor 320 and a multi-stage stator 350 in a radial direction as well as in an axial direction.

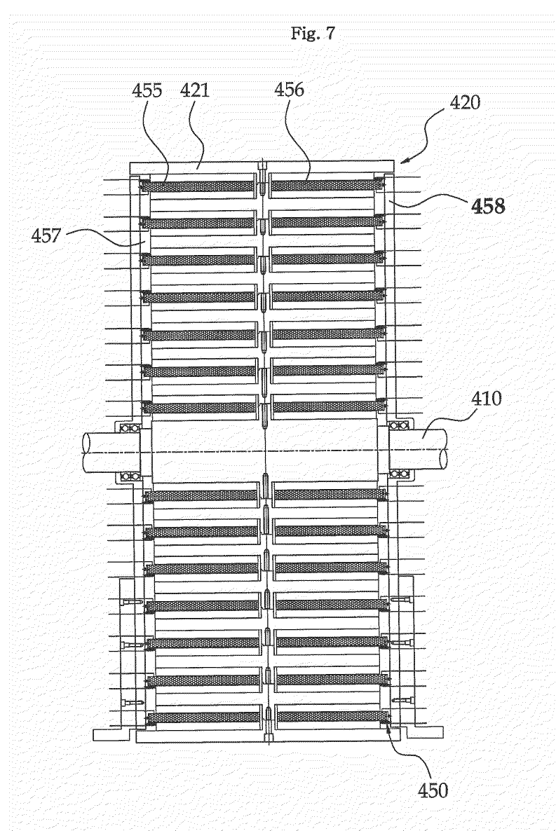

FIG. 7 is a sectional view showing a motor having a multi-stage rotor according to a still further embodiment of the present invention. The motor of FIG. 6 includes the fixed shaft 310, whereas the motor of FIG. 7 includes a rotating shaft.

The motor of FIG. 7 includes a rotating shaft 410, a rotor 420 and a stator 450.

The rotor 420 includes yokes 421 which are arranged in two stages in an axial direction and also arranged in multiple stages in a radial direction. Further, the yokes arranged in multiple stages in a radial direction are detachably coupled.

The stator 450 includes fixed disks 457 and 458, and armature coil assemblies. The fixed disks 457 and 458 are arranged in two stages in an axial direction and rotatably coupled to the rotating shaft 410. The armature coil assemblies include a first row of armature coil assemblies 455 and a second row of armature coil assemblies 456, which are arranged in multiple stages in a radial direction and then arranged in an axial direction. The first row of armature coil assemblies 455 are detachably coupled to the first fixed disk 457, while the second row of armature coil assemblies 456 are detachably coupled to the second fixed disk 458.

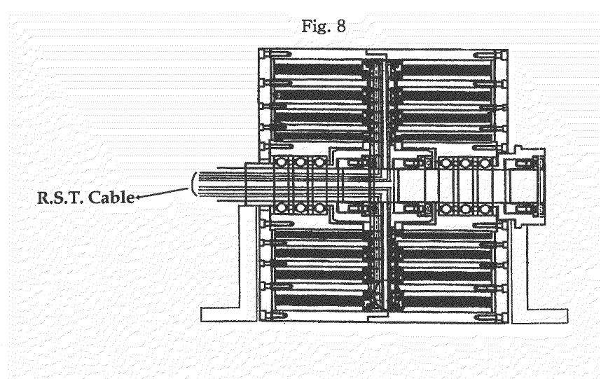

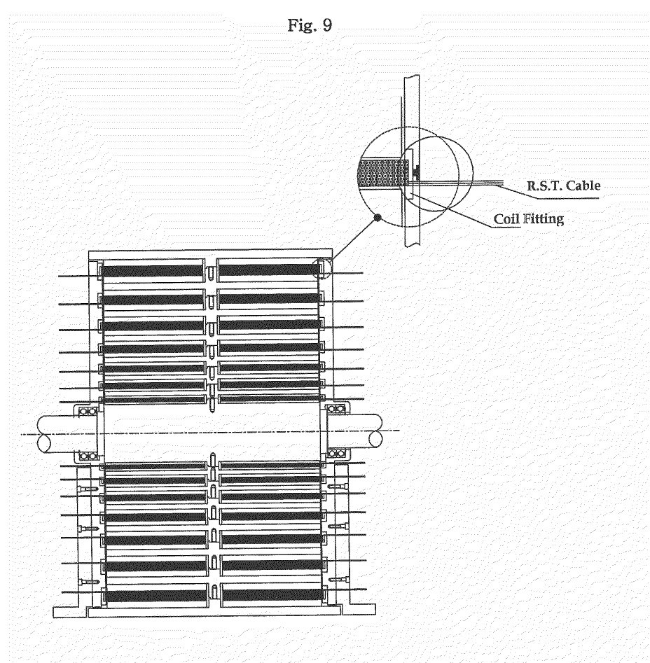

FIGS. 8 and 9 are sectional views showing a motor having a multi-stage rotor according to a still further embodiment of the present invention.

In the embodiments shown in FIGS. 6 and 7, both the magnets and the armature coil assemblies are formed to have the same thickness in a radial direction. However, the motor may include magnets and armature coil assemblies whose thicknesses vary in a radial direction, if desired. In the embodiments shown in FIGS. 8 and 9, the motor includes magnets and armature coil assemblies whose thicknesses are decreased as radial distances from a central axis of the shaft are decreased.

Next, a driving apparatus including the coreless motor having a multi-stage rotor according to the present invention will be explained.

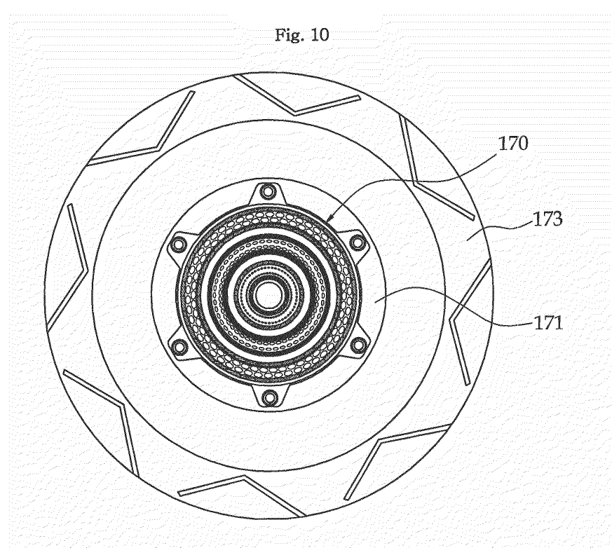

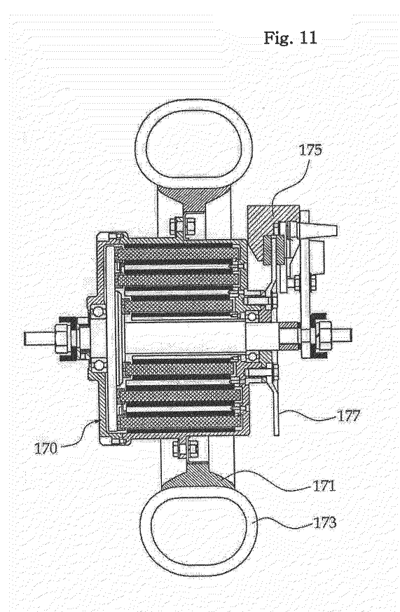

FIG. 10 is a front sectional view showing a driving apparatus using the motor of the embodiment shown in FIG. 5, and FIG. 11 is a side sectional view of the driving apparatus shown in FIG. 10.

The driving apparatus of FIGS. 10 and 11 includes the motor 170 shown in FIG. 5, a brake disk 177 and a caliper 175. The brake disk 177 is fixed to one side of the rotating disk 141 of the motor 170. The caliper 175 is also installed to one side of the brake disk 177, and one side thereof is fixed to the fixed shaft 110. If the rotor 120 of the motor 170 is fixed to a wheel 171 of a tire 173 as shown in FIGS. 10 and 11, the motor may be used as a driving apparatus of a car, a vehicle or a motor. Thus, if electric power is supplied to the armature coil assemblies 151, 153 and 155, the rotor 120 is rotated and the tire 173 is rotated accordingly. Further, if the brake disk 177 is pressed toward the rotating disk using the caliper 175, the rotor 120 is stopped. Although the driving apparatus of FIG. 10 employs the motor shown in FIG. 5, the present invention is not limited thereto. That is, any motors of other embodiments may also be used therein.

### INDUSTRIAL APPLICABILITY

According to the present invention, a motor including a multi-stage stator and a multi-stage rotor, which are arranged in multiple stages and rows, can be provided to reduce a volume of the motor and also to increase an output of the motor.

Further, a coreless motor is provided in the present invention to allow weight of the motor to be reduced and to prevent a cogging torque from being produced. Thus, the reduction in output of the motor can be prevented to maximize efficiency of the motor, and smooth rotation of the motor can be performed to suppress noise and vibration of the motor.

Furthermore, the motor can be applied to a driving apparatus to implement a car, vehicle or motorcycle with excellent driving performance.

The embodiments of the present invention described above and illustrated in the drawings should not be construed to limit the technical spirit of the present invention. The scope of the present invention is defined only by the appended claims, and it will be understood by those skilled in the art that various modifications and changes can be made thereto without departing from the spirit and scope of the present invention defined by the appended claims. Therefore, such modifications and changes will be included in the scope of the present invention, if they are apparent to those skilled in the art.

1. A coreless motor including a multi-stage rotor, comprising:
a rotor including a plurality of cylindrical yokes arranged in multiple stages in a radial direction, and a plurality of magnets fixed to the yokes in the respective stages in such a manner that polarities of the magnets fixed to the yoke in each stage are changed in a circumferential direction of the yoke; and
a stator including a plurality of cylindrical armature coil assemblies arranged in multiple stages to face the yokes, each armature coil assembly including a plurality of armature coils.

2. The coreless motor as claimed in claim 1, wherein the magnets are fixed to circumferential surfaces of the yokes facing in the radial direction.

3. The coreless motor as claimed in claim 2, further comprising a fixed shaft positioned at a rotation center of the rotor, wherein the rotor further includes a yoke coupling means for rotatably coupling each of the yokes to the fixed shaft, and the stator further includes a coil coupling means for fixedly coupling each of the armature coil assemblies to the fixed shaft.

4. The coreless motor as claimed in claim 3, wherein each of the armature coil assemblies is detachably coupled to the coil coupling means.

5. The coreless motor as claimed in claim 4, wherein a yoke positioned inside an inner circumference of the armature coil assembly is detachably coupled to the yoke coupling means.

6. The coreless motor as claimed claim 5, wherein the coil coupling means is a fixed disk whose one surface is detachably coupled to one side of each armature coil assembly, and the fixed disk is fixedly coupled to the fixed shaft.

7. The coreless motor as claimed in claim 6, wherein the yoke coupling means is a rotating disk whose one surface is coupled to one side of each yoke, and the rotating disk is rotatably coupled to the fixed shaft.

8. The coreless motor as claimed in claim 2, further comprising a rotating shaft positioned at a rotation center of the rotor, wherein the rotor further includes a yoke coupling means for fixedly coupling each of the yokes to the rotating shaft, and the stator further includes a coil coupling means for rotatably coupling each of the armature coil assemblies to the rotating shaft.

9. The coreless motor as claimed in claim 8, wherein each of the armature coil assemblies is detachably coupled to the coil coupling means.

10. The coreless motor as claimed in claim 9, wherein the coil coupling means is a fixed disk whose one surface is detachably coupled with one side of each armature coil assembly, and the fixed disk is rotatably coupled to the rotating shaft.

11. The coreless motor as claimed in claim 10, wherein the yoke coupling means is a rotating disk whose one surface is coupled to one side of each yoke, and the rotating disk is fixedly coupled to the rotating shaft.

12. The coreless motor as claimed in claim 11, wherein the rotor further includes a yoke fixed to the rotating shaft.

13. The coreless motor as claimed in claim 12, wherein a yoke positioned between the armature coil assemblies adjacent to each other is detachably coupled to the one surface of the rotating disk.

14. The coreless motor as claimed in claim 1, wherein the rotor further includes yokes and magnets additionally arranged in at least one more stage in an axial direction, and the stator further includes a plurality of armature coil assemblies additionally arranged to face the additional yokes.

15. The coreless motor as claimed in claim 14, wherein the magnets are fixed to circumferential surfaces of the yokes facing in the radial direction.

16. The coreless motor as claimed in claim 15, further comprising a fixed shaft positioned at a rotation center of the rotor, wherein the rotor further includes a yoke coupling means for rotatably coupling each of the yokes to the fixed shaft, and the stator further includes a coil coupling means for fixedly coupling each of the armature coil assemblies to the fixed shaft.

17. The coreless motor as claimed in claim 16, wherein each of the armature coil assemblies is detachably coupled to the coil coupling means.

18. The coreless motor as claimed in claim 17, wherein each of the yokes is detachably coupled to the yoke coupling means.

19. The coreless motor as claimed in claim 18, wherein the coil coupling means is a plurality of rotating disks arranged in multiple stages in an axial direction, and one surface of each rotating disk is detachably coupled to one side of each of the armature coil assemblies arranged in multiple stages in the radial direction.

20. The coreless motor as claimed in claim 19, wherein the yoke coupling means is a plurality of fixed disks arranged in multiple stages in an axial direction, and one surface of each fixed disk is coupled to one side of each of the yokes arranged in multiple stages in the radial direction.

21. The coreless motor as claimed in claim 15, further comprising a rotating shaft positioned at a rotation center of the rotor, wherein the rotor further includes a yoke coupling means for fixedly coupling each of the yokes to the rotating shaft, and the stator further includes a coil coupling means for rotatably coupling each of the armature coil assemblies to the rotating shaft.

22. The coreless motor as claimed in claim 21, wherein each of the armature coil assemblies is detachably coupled to the coil coupling means.

23. The coreless motor as claimed in claim 22, wherein the yoke coupling means detachably couples each of the yokes to the rotating shaft.

24. The coreless motor as claimed in claim 23, wherein the coil coupling means is a plurality of rotating disks arranged in multiple stages in an axial direction, and one surface of each rotating disk is detachably coupled to one side of each of the armature coil assemblies arranged in multiple stages in the radial direction.

25. A driving apparatus, comprising:
a motor according to claim 3;
a brake disk fixed to the rotor of the motor; and
a caliper installed to one side of the brake disk to restrict rotation of the brake disk.

26. The driving apparatus as claimed in claim 25, wherein the caliper is fixed to one side of the fixed shaft.

27. A driving apparatus, comprising:
a motor according to claim 16;
a brake disk fixed to the rotor of the motor; and
a caliper installed to one side of the brake disk to restrict rotation of the brake disk.

28. The driving apparatus as claimed in claim 27, wherein the caliper is fixed to one side of the fixed shaft.

29. A driving apparatus, comprising:
a motor according to claim 4;
a brake disk fixed to the rotor of the motor; and
a caliper installed to one side of the brake disk to restrict rotation of the brake disk.

30. A driving apparatus, comprising:
a motor according to claim 5;
a brake disk fixed to the rotor of the motor; and
a caliper installed to one side of the brake disk to restrict rotation of the brake disk.

31. A driving apparatus, comprising:
a motor according to claim 6;
a brake disk fixed to the rotor of the motor; and
a caliper installed to one side of the brake disk to restrict rotation of the brake disk.

32. A driving apparatus, comprising:
a motor according to claim 7;
a brake disk fixed to the rotor of the motor; and
a caliper installed to one side of the brake disk to restrict rotation of the brake disk.

33. A driving apparatus, comprising:
a motor according to claim 17;
a brake disk fixed to the rotor of the motor; and
a caliper installed to one side of the brake disk to restrict rotation of the brake disk.

34. A driving apparatus, comprising:
a motor according to claim 18;
a brake disk fixed to the rotor of the motor; and
a caliper installed to one side of the brake disk to restrict rotation of the brake disk.

35. A driving apparatus, comprising:
a motor according to claim 19;
a brake disk fixed to the rotor of the motor; and
a caliper installed to one side of the brake disk to restrict rotation of the brake disk.

36. A driving apparatus, comprising:
a motor according to claim 20;
a brake disk fixed to the rotor of the motor; and
a caliper installed to one side of the brake disk to restrict rotation of the brake disk.
